(19) United States
(12) Patent Application Publication
(10) Pub. No.: US 2026/0280451 A1
(43) Pub. Date: Sep. 17, 2026

(54) Conformal Thrust Generation by Strong Binding Energy Release in Quantum Capillary Lattices

(71) Applicants: Rodolfo Carrera, Austin, TX (US); Elena Montalvo, Austin, TX (US)

(72) Inventors: Rodolfo Carrera, Austin, TX (US); Elena Montalvo, Austin, TX (US)

(21) Appl. No.: 19/363,069

(22) Filed: Oct. 20, 2025

Related U.S. Application Data
(63) Continuation-in-part of application No. 18/534,343, filed on Dec. 8, 2023.

(51) Int. Cl. H02N 11/00; H01F 7/06

(52) U.S. Cl. CPC H02N 11/006; H01F 7/064

(57) ABSTRACT

A method and system including introducing one or more types of nuclei into a cavity of a capillary and sending a current pulse along at least one of one or more conductors surrounding the cavity of the capillary. The current pulse is configured to generate an electromagnetic field pulse within the cavity. A positive voltage is applied to at least one of the conductors surrounding the capillary. The nuclei are bounded-chain focalized along an axis of the cavity of the capillary. The nuclei interact and generate one or more resulting types of nuclei. The resulting types of nuclei acquire kinetic energy in an upward and in a downward direction. The nuclei in an upward direction are redirected in the downward direction, with all the nuclei in the downward direction generating thrust in the upward direction.

### A. RELATED APPLICATIONS

This application is a continuation-in-part of and claims the benefit of the filing date of U.S. patent application Ser. No. 18/534,343, filed on Dec. 8, 2023, the entire contents of which are hereby incorporated by reference herein.

### B. BACKGROUND

The invention relates generally to inducing integral clustering in metastable chain states to generate thrust.

### C. BRIEF DESCRIPTION OF THE DRAWINGS

Other objects and advantages of the invention may become apparent upon reading the detailed description and upon reference to the accompanying drawings.

FIG. 1 is a quantum capillary lattice micromodule having a plurality of quantum capillaries, in accordance with some embodiments.

FIG. 2 is a side view of a quantum capillary lattice micromodule, in accordance with some embodiments.

FIG. 3 is a vertical cross-sectional view of a quantum capillary lattice micromodule, in accordance with some embodiments.

FIG. 4 is a horizontal cross-sectional view of an anode of a quantum capillary lattice micromodule, in accordance with some embodiments.

FIG. 5 is a second horizontal cross-sectional view of a cathode of a quantum capillary lattice micromodule, in accordance with some embodiments.

FIG. 6 is a side view and a cross-sectional view of a quantum capillary, in accordance with some embodiments.

FIG. 7 is a diagram of a capillary electrical circuit, in accordance with some embodiments.

FIG. 8 is a graph of a current pulse supplied to a conductive layer of a capillary, in accordance with some embodiments.

FIG. 9 is another diagram of a quantum capillary electrical circuit, in accordance with some embodiments.

FIG. 10 is a diagram of an electrical circuit of a ring electrode at the orifice of a quantum capillary, in accordance with some embodiments.

FIG. 11 is a block diagram of an anode and charged-coupled cathode electrical circuit, in accordance with some embodiments.

FIG. 12 is a cross-sectional view of an open quantum capillary, in accordance with some embodiments.

FIG. 13 is sectional view of a quantum capillary with a vent, in accordance with some embodiments.

FIG. 14 is a cross-sectional view of a capillary link, in accordance with some embodiments.

FIG. 15 is a cross-sectional view of a capillary cell rod, in accordance with some embodiments.

FIG. 16 is a cross-sectional view as well as a top view of a disk arrangement of thrust cells, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### D. DETAILED DESCRIPTION

It should be noted that the devices shown are not necessarily to scale, the number of features shown are exemplary, and the dimensions shown are also exemplary.

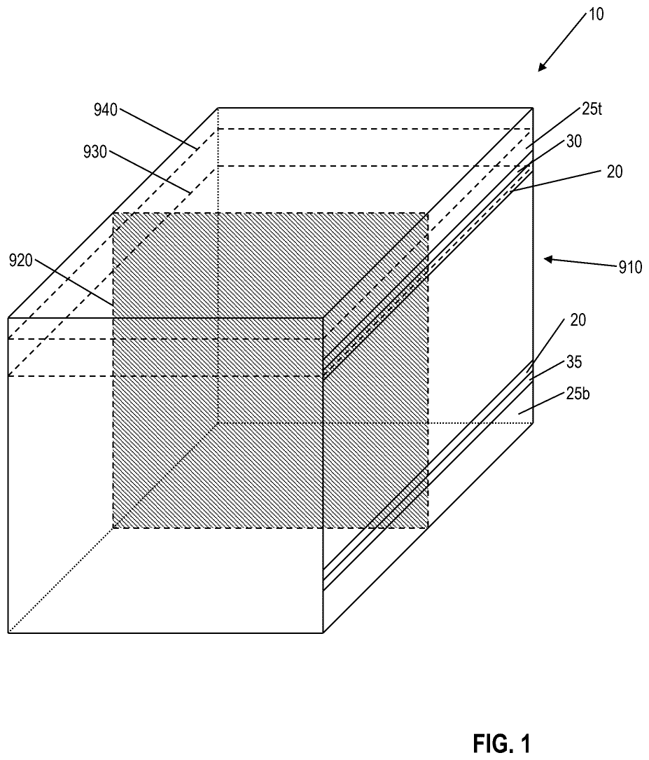

FIG. 1 is a quantum capillary lattice micromodule having a plurality of quantum capillaries, in accordance with some embodiments.

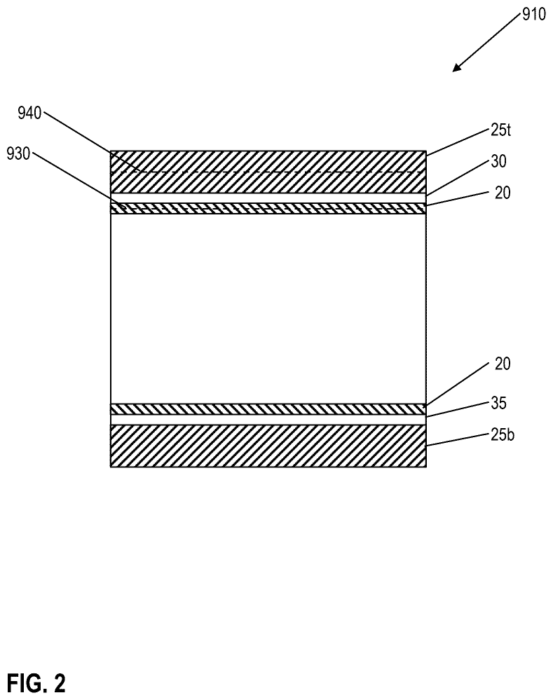

FIG. 2 is a side view of a quantum capillary lattice micromodule, in accordance with some embodiments.

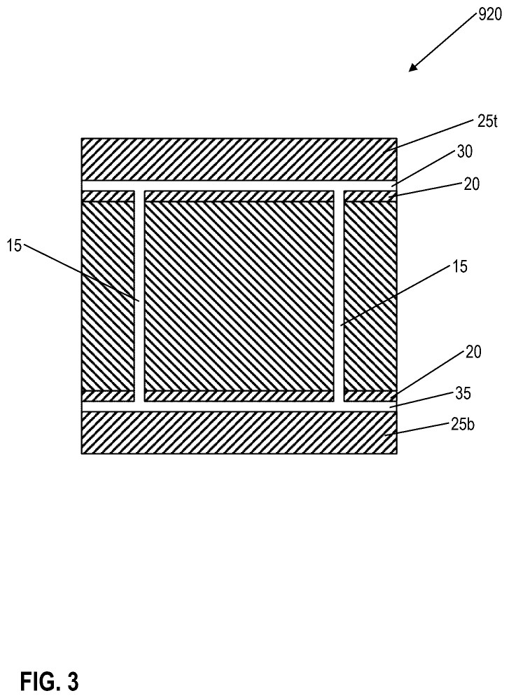

FIG. 3 is a vertical cross-sectional view of a quantum capillary lattice micromodule, in accordance with some embodiments.

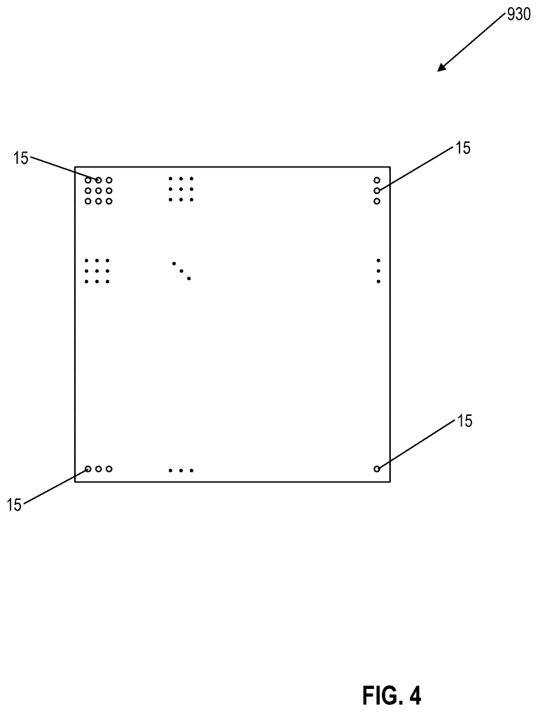

FIG. 4 is a horizontal cross-sectional view of an anode of a quantum capillary lattice micromodule, in accordance with some embodiments.

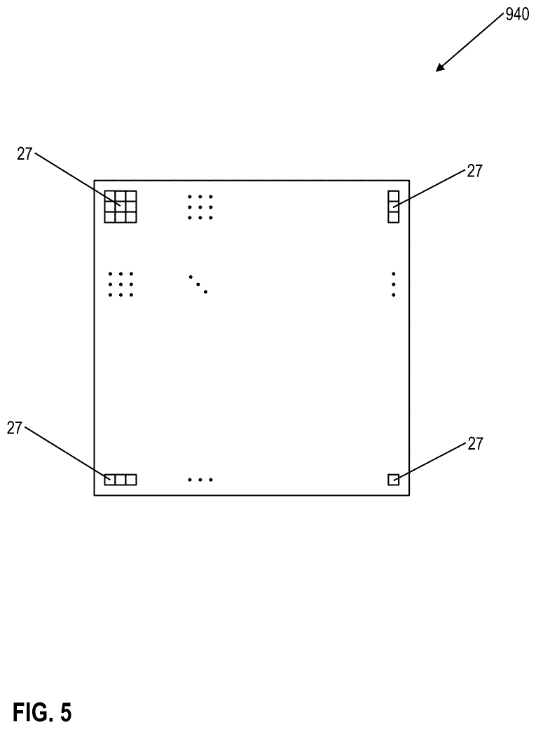

FIG. 5 is a second horizontal cross-sectional view of a cathode of a quantum capillary lattice micromodule, in accordance with some embodiments.

FIG. 2 shows side view 910 of quantum capillary lattice micromodule 10, in accordance with some embodiments.

FIG. 3 shows vertical cross-sectional view 920 of quantum capillary lattice micromodule 10, in accordance with some embodiments.

FIG. 4 shows horizontal cross-sectional view 930 of anode 20 of quantum capillary lattice micromodule 10, in accordance with some embodiments.

FIG. 5 shows horizontal cross-sectional view 940 of cathode 25 of quantum capillary lattice micromodule 10, in accordance with some embodiments.

In some embodiments, quantum capillary lattice micromodule 10 comprises an anode 20 and a cathode 25. In some embodiments, micromodule 10 may include anode 20, and two cathodes, a top cathode 25t and a bottom cathode 25b (collectively referred to as cathode 25).

In some embodiments, micromodule 10 comprises gas inlet 35 and gas inlet 30. In some embodiments, particles (for example, atoms) that are to interact within micromodule 10 (to generate electricity, for example) may be supplied by a supply source and enter micromodule 10 through gas inlets 30 and 35.

In some embodiments, micromodule 10 comprises a plurality of quantum capillaries 15. In some embodiments, capillaries 15 may be arranged vertically in an array (for example, a 100×100 array of capillaries) within micromodule 10.

In some embodiments, cathode 25 may be a split charge-coupled cathode with surface pixel structures 27 (for example, a 100×100 array of surface pixel structures) corresponding to and aligned with, for example, the 100×100 capillaries 15. Cathode 25 and anode 20 may be configured to generate electricity (as will be discussed in more detail below) and are thus also configured to be coupled to an external load, for example.

In some embodiments, the integrated micromodule may be designed with a volume of ≈1 cm³ and a total capillary surface≈1 cm². In some embodiments, each anode may include approximately 104 capillaries per cm² having a length of ≈10 mm and a radius of ≈100 nm. In some embodiments, the separation distances of anode capillaries and cathode pixel structures are ≈100 μm.

In some embodiments, the quantum capillaries array is fed by a regulated near normal temperature and pressure (NTP) gas mix flow.

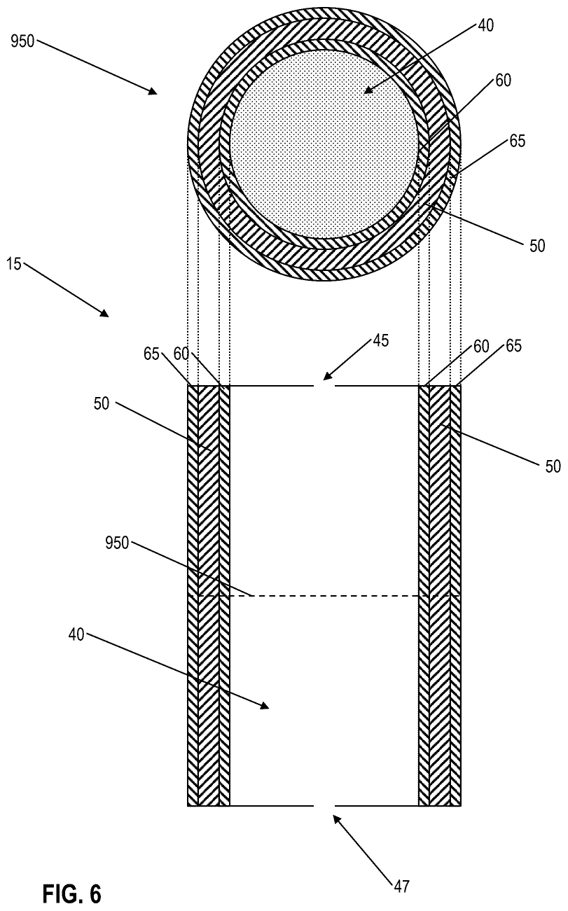

FIG. 6 is a side view and a cross-sectional view of a quantum capillary, in accordance with some embodiments.

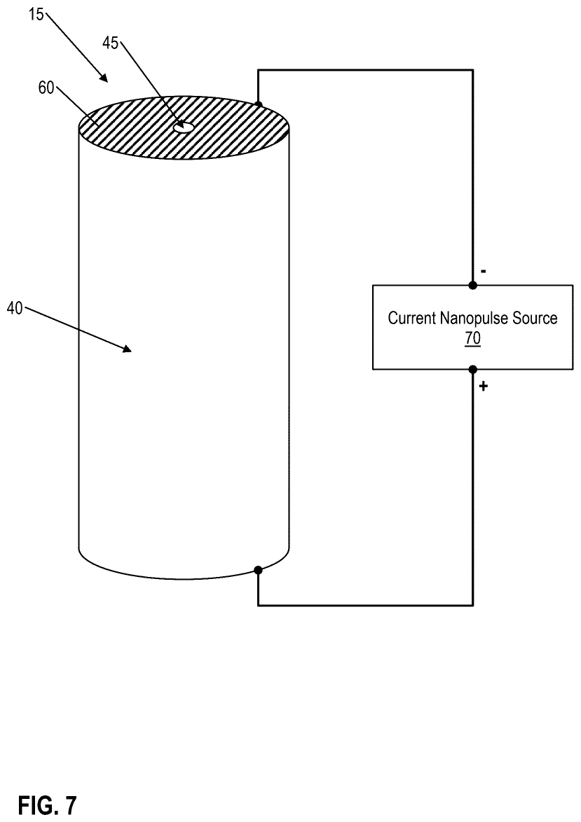

FIG. 7 is a diagram of a capillary electrical circuit, in accordance with some embodiments.

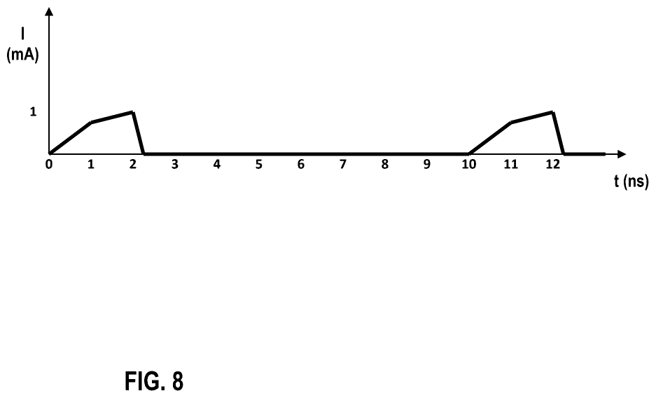

FIG. 8 is a graph of a current pulse supplied to a conductive layer of a capillary, in accordance with some embodiments.

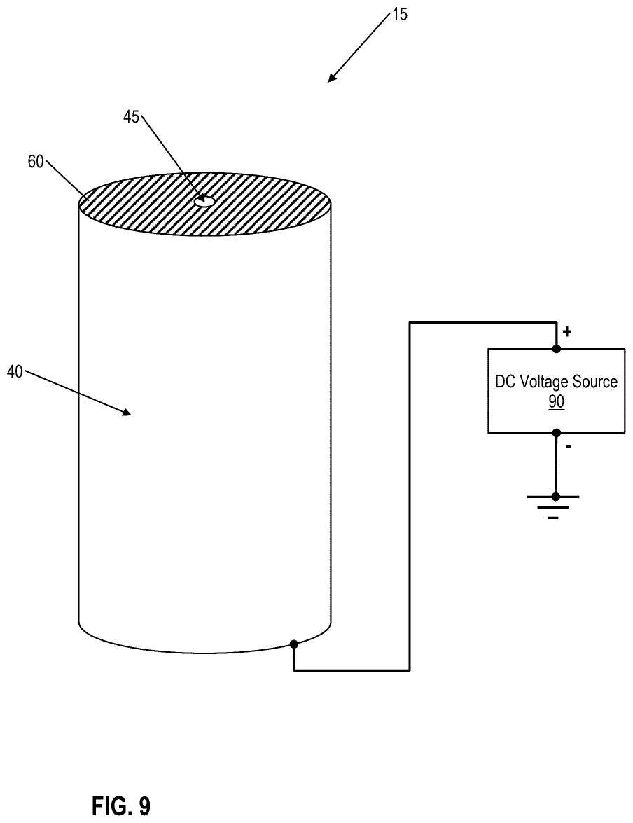

FIG. 9 is another diagram of a quantum capillary electrical circuit, in accordance with some embodiments.

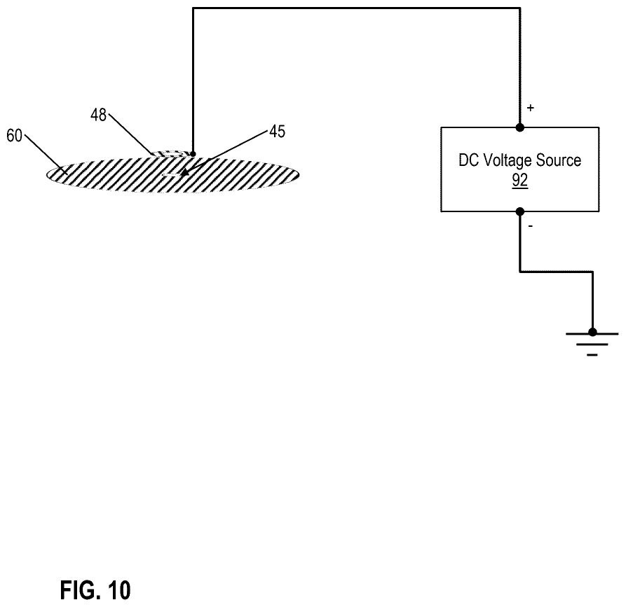

FIG. 10 is a diagram of an electrical circuit of a ring electrode at the orifice of a quantum capillary, in accordance with some embodiments.

In some embodiments, capillary 15 (which may be one of many in an array of capillaries within micromodule 10, for example) may comprise a conductor such as conductive layer 60, which may be a cylindrical conductive layer, made of graphene-type or similar material, for example. In some embodiments, other suitable conductive materials may be used, especially ones having very low resistivity. Another example of such conductive material would be multi-walled carbon nanotubes.

In some embodiments, conductive layer 60 may extend to the top and bottom bases of capillary 15. In alternative embodiments, a separate conductive layer may be used at the top and bottom bases or at the lateral side of capillary 15. In some embodiments, conductive layer 60 defines cavity 40 within capillary 15.

In alternative embodiments, conductive layer 60 may generally be any conductor in the vicinity/near and/or surrounding capillary 15 such as one or more wires, one or more coiled wires, etc. In yet other alternative embodiments, multiple conductors may be used.

In some embodiments, capillary 15 comprises an electromagnetic reflector such as electromagnetic reflective layer 50 to the outside and laterally surrounding conductive layer 60. In some embodiments, reflective layer 50 is configured to provide a magnetically reflective boundary as will be discussed further below. In some embodiments, capillary 15 may also comprise insulating layer 65 to the outside and surrounding reflective layer 50. In some embodiments, conductive layer 60, reflective layer 50, and insulating layer 65 may be referred to collective as a multilayer clad surrounding capillary 15.

In some embodiments, capillary 15 comprises two nano-orifices: orifice 45 and orifice 47 respectively at the top and bottom of capillary 15. Orifice 45 and orifice 47 may be connected to a regulated source of gas (in some embodiments near normal temperature and pressure) made of atoms whose nuclei are to interact inside capillary 15. For example, the gas may comprise low atomic number atoms, such as ¹¹B and ¹H, at near normal temperature and pressure (NTP) conditions. Other types of atoms may be used including atoms of the same type, atoms of two or more different types, etc.

In some embodiments, the capillary may contain a non-equilibrium ensemble in the order of a billion particles. In some embodiments, capillary 15 may have a radius of 100 nm with orifice 45 orifice 47 having radii of 1 nm (which may be in the order of the gas particle interspacing distance). Capillary 15 may have a length/height of 10 mm and may be embedded within an integrated quantum capillary lattice made of similar capillaries within micromodule 10.

In some embodiments, conductive layer 60 is configured to be coupled to current nanopulse source 70, as is shown in FIG. 7, for example. Nanopulse source 70 is configured to generate a pulsed current axially oriented via conductive layer 60, with the pulsed current generating a cylindrical (in embodiments where the conductive layer is cylindrical) magnetic wavefront that converges, after being reflected from reflective layer 50, radially inwards toward the axis of cavity 40 of capillary 15. As discussed above, conductive layer 60 may have other shapes, and as such, electromagnetic field wavefronts/pulses with alternative profiles may be generated. In alternative embodiments, the current pulse may be sent to one or more multiple conductors in near capillary 15.

An example profile of the pulsed current is shown in FIG. 8. In some embodiments, the conductive layer 60 bounded-chain focalization pulse may have a current maximum of 1 mA, a voltage of 10 V, and a duration of 1 ns with a ramp up of 1 ns. In some embodiments, every 10 ns, the current pulse may be then sequentially cycled through the other capillaries (100×100, in some embodiments) of micromodule 10. Thus, the pulse, in such embodiments, may be repeated in each capillary every 100 μs. In some embodiments, the pulse current density may be in the order of 107 A/cm².

In some embodiments, DC voltage source 90 is configured to be connected to conductive layer 60 as is shown in FIG. 9. In some embodiments, the positive of DC voltage source 90 may be connected to the bottom (or any other portion) of conductive layer 60 and the negative may be connected to ground. In alternative embodiments, an electric field profile around the cavity can be generated/established with DC and/or AC voltage sources and/or voltage sources with other profiles. In alternative embodiments, connections may be made to the top and bottom of conductive layer 60. Other configurations may also be used depending on the number and locations of the conductors present near capillary 15. In some embodiments, the positive bias voltage applied to conductive layer 60 is configured to generate electric fields that, at least in part, maintain the nuclei within cavity 40 during their interaction. As discussed above, conductive layer 60 may have other shapes, and as such, electric fields with alternative profiles may be generated. It should also be noted that the electromagnetic field pulse/wavefront and the electric fields may be generated using separate conductors/conductive layers. In alternative embodiments, positive voltage may be applied to one or more of the multiple conductors near capillary 15 or electric field profiles may be generated in alternative methods.

In some embodiments, ring electrodes may be placed above orifice 45 and orifice 47. FIG. 10 shows electrode 48 above orifice 45. Similar electrodes may be placed above orifice 47 (not shown).

In some embodiments, DC voltage 92 may be connected to the electrodes. In some embodiments, the positive of DC voltage source 92 may be connected to electrode 48 (and to the outside of the not shown bottom electrode) and the negative of DC voltage source 92 may be connected to ground. It should be noted that, in some embodiments, DC voltage source 90 and DC voltage source 92 may be the combined into one DC voltage source.

In some embodiments, the applied voltage is configured to generate a high electric field at orifice 45 and orifice 47 based at least on the ring electrodes having thin walls. In some embodiments, the ring electrodes may have walls having a thickness in the order of 10 nm.

In some embodiments, as atoms in the gas diffuse into cavity 40 of capillary 15 through orifice 45 and orifice 47, the high electric field generated by the ring electrodes near orifice 45 and orifice 47 is configured to remove the electrons from the particles/atoms (through field absorption, for example) creating nuclei.

In some embodiments, an effusion DC voltage in the order of 0.1 V may be applied. In some embodiments, an electron of an atom passing through an orifice experiences a perimeter-integrated electric field stronger than the one experienced by the shell electrons.

It should be noted that electrons may be removed from the entering gas atoms using high electric fields generated directly at orifice 45 and orifice 47 by the DC voltage 92 applied to ring electrode 48 and to the bottom electrode (not shown).

In some embodiments, filling by pressure balance through the orifices maintains capillary's cavity particle number after operational losses. In some embodiments, a particle flow may be maintained through capillary 15 in order to replace particles that have already interacted and been consumed as will be seen below. In some embodiments, a flow in the order of 0.1 picoliter/s may be maintained with a particle orifice pass-through period in the order of 0.1 ns.

In some embodiments, transient 1D-space ordering of the capillary free particles may be induced by the current nanopulse in conductive layer 60 and held, at least partially, within cavity 40 by the DC bias voltage. The particle nanocloud within cavity 40 may radially and near-reversibly oscillate between singularly bounded-chain focalized (with the current pulse on) and outset nanocloud states (with the current pulse off).

In some embodiments, the current pulse through conductive layer 60 generates a radial electromagnetic wavefront of uniform cylindrical (in embodiments where the conductive layer is cylindrical) intensity and timing. Conductive layer 60 may act as a space and time lens leading to singular bounded-chain focalization (that is, axi-symmetric bounded-chain focalization to sub-picometer 1D ordering on the axis of cavity 40).

In some embodiments, the ultrafast azimuthal electromagnetic field pulse created by the pulsed current is reflected inward by reflective layer 50 that acts as a focusing lens. Throughout the pulse, the particle nanocloud is radially bounded-chain focalized by the wavefront and is axially bounded on the axis of cavity 40 by the electric fields at orifice 45 and at orifice 47 generated by the bias voltage. In some embodiments, bounded-chain focalization may be a radial process (with axial uniformity and angular isotropy), constraining the nuclei nanocloud to an axial 1D chain.

In some embodiments, the bounded-chain focalization pulse has a peripheral wavefront pressure in the order of 10 mPa at the lateral surface of cavity 40. In some embodiments, the pulse's energy is focused simultaneously on the cavity axis where the nuclei nanocloud may be ordered in 1D along the axis of cavity 40.

In some embodiments, the wavefront's radial convergence counters the increasing doublet nuclei azimuthal coulomb repulsion. The force exerted by the wavefront may be larger than the doublet nuclei azimuthal coulomb repulsion force making it possible for an interaction through quantum tunnelling of the nuclei particles within cavity 40.

In some embodiments, during the bounded-chain focalization process, the nanocloud may be in a 1D state (with the nuclei radial distribution going from approximately 100 nm nanocloud to a less than a 1 μm linear chain).

In embodiments where the gas atoms introduced into capillary 15 are ¹H¹ and ¹¹B⁵ atoms, the bounded-chain focalization of the nanocloud induces degenerate ¹H¹⁺ and ¹¹B⁵⁺ pairs in 1D space along the axis of cavity 40. In some embodiments, the lifetime of the induced metastable bound pair state (and associated metastable linear chain state) may be in the order of 1 ns. Bounded-chain focalization allows localized states with pair chain configuration within an axial 1D space with sub-picometer radial extent.

In some embodiments, the nanocloud focusing force in the 1D space may be in the order of 1 mN, which is larger than the value of the repulsion force between the constrained doublet nuclei, which is in the order of 100 μN. The pairs may be axially separated by ≈10 μm (each pair constrained by two contiguous pairs) with their repulsion force being in the order of 1000 μN balanced by each pair inner repulsion force.

In some embodiments, it may be energetically favorable for a ¹H¹⁺ nucleus to intercalate between a ¹¹B⁵⁺ nucleus and a contiguous ¹¹B⁵⁺ nucleus in the 1D space. Doublet charge-asymmetry may induce ordering of the fixed-length 1D distribution, intercalating each of the ¹H¹⁺ nuclei between two ¹¹B⁵⁺ nuclei. The bounded-chain focalized 1D intercalate order distribution forms a force-balance bounded-chain focalization-driven ¹H¹⁺−¹¹B⁵⁺ nuclei pair chain (a bounded periodic 1D linear ordering of ¹H¹⁺−¹¹B⁵⁺ nuclei pairs along the capillary axis) within the radial extent of pair bounded-chain focalization.

In some embodiments, the ¹H¹⁺−¹¹B⁵⁺ nuclei pair linear chain may be sustained by the electric field induced at orifice 45 and orifice 47, with fixed axial boundary conditions during the pulse flat top. In some embodiments, the electric field generated by the capillary thin-edged orifices near their center balance out the nuclei pairs linear chain repulsion force, which may be in the order of 1000 μN.

In some embodiments, pair chain bounding may occur on axis where the electric field repulsion force applied to axial linear chain boundaries has a symmetric contribution from the entire equidistant orifice perimeter during the nanopulse.

In embodiments where the gas atoms introduced into capillary 15 are ¹H¹ and ¹¹B⁵ atoms, spontaneous bounded-chain focal plane 1D-space ordering proceeds with bounded-chain focal plane degeneration via collective doublet-to-pair quantum transitioning. At radial extent of pair bounded-chain focalization, doublet axial intercalation, coulomb force balancing, and wavefunction overlapping, induce degenerate pairing with pair chain formation (time scale in the order of 1 as).

As such, bounded-chain focalization may drive the ensemble nuclei in a metastable repeating pattern of pair degenerate pair states that hold during the pulse (in the order of 1 ns in duration), and where quantum tunneling is mediated by chain pair coulomb force balance. Residual strong interaction on the chain pair nuclei may induce some integral ⁴He²⁺ cluster states that undergo triplet split decaying by emission of three charge carriers ⁴He²⁺ (time scale in the order of 100 as) in embodiments where ¹H¹⁺ and ¹¹B⁵⁺ nuclei are introduced into cavity 40. In some embodiments, the interaction may be represented as:

$${1}^{} {H}^{1 +} {+}^{11} {B}^{5 +} -> {3}^{4} {He}^{2 +} .$$

In some embodiments, quantum tunneling induces the metastable ¹H¹⁺−¹¹B⁵⁺ nuclei pair state to transition into an integral ⁴He²⁺ cluster state mediated by fast residual strong interaction between pair component nucleons. Some of the linear chain pairs form short-lived integral ⁴He²⁺ cluster structures preserving both proton and neutron numbers with no weak interaction involved, that spontaneously decay by triplet splitting into three high energy ⁴He²⁺ charge carriers with average total kinetic energy for the three ⁴He²⁺ in the order of 1 pJ.

In some embodiments, during the pulse, the ¹H¹⁺+11B⁵⁺ nuclei couple to form a 1D quantum pair chain with ≈105 ⁴He²⁺ cluster quantum states that undergo spontaneous decay by triplet splitting into stable ⁴He²⁺ nuclei of high kinetic energy (average triplet kinetic energy in the order of 1 pJ). The energy source for the emission is the cluster state binding energy mediated by the nucleons' residual strong interaction.

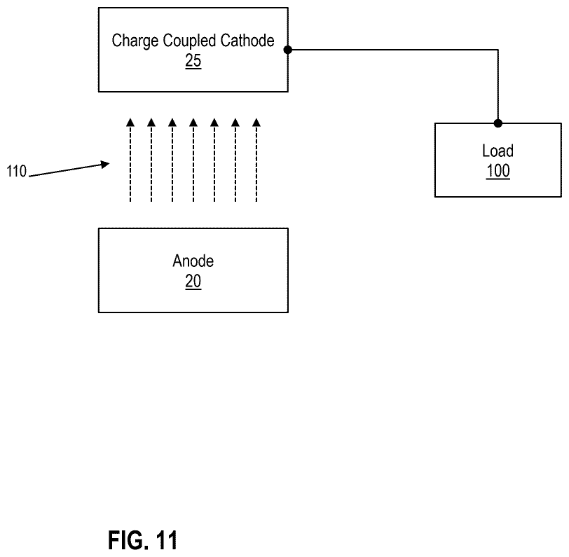

FIG. 11 is a block diagram of an anode and charged-coupled cathode electrical circuit, in accordance with some embodiments.

In some embodiments, the charged carriers 110 resulting from the nuclear interaction and emerging from anode 20 may be converted into electricity via a charged couple cathode device 25. The electricity may be then utilized by load 100.

In embodiments where the interactions are between ¹¹B⁵⁺ and ¹H¹⁺ nuclei, the resulting ⁴He²⁺ nuclei triplets may be emitted with average kinetic energy in the order of =1 pJ from an average ¹H¹⁺−¹¹B⁵⁺ nuclei pair average kinetic energy being in the order of ≈100 aJ.

In some embodiments, the high kinetic energy ⁴He²⁺ nuclei streamline (with emission radial motion conversion to axial motion through energy barrier interaction) to the split cathode 25 top-bottom surfaces out of capillary 15 axis and thus being unimpeded by the edge electric field in the capillary's 15 orifices.

In some embodiments, the ⁴He²⁺ nuclei streamline toward the charged coupled cathode 25 and strike cathode 25. In some embodiments, a lattice of pixel structures may exist for each micromodule 10.

As a result, electrons are dislodged in the thin charge-coupled cathode pixel structures by the high kinetic energy ⁴He²⁺ nuclei and are collected by semiconductor junctions for subsequent release, generating a direct electronic current and thus electricity.

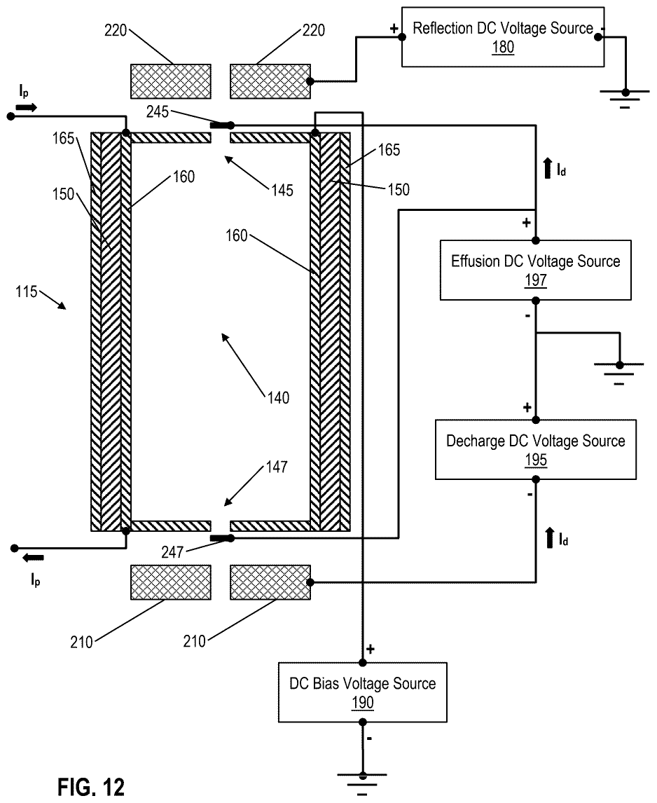

FIG. 12 is a cross-sectional view of an open quantum capillary, in accordance with some embodiments.

In some embodiments, open capillary 115 may comprise a conductor such as conductive layer 160, which may be a cylindrical conductive layer and may be made of a graphene-type or similar material, for example. In other embodiments, any conductive material may be used, preferably one having low resistivity. Another example of such conductive material would be multi-walled carbon nanotubes.

In some embodiments, conductive layer 160 may extend to the top and bottom bases of open capillary 115. In alternative embodiments, a separate conductive layer may be used at the top and bottom bases compared to the lateral side of open capillary 115. In some embodiments, conductive layer 160 defines cavity 140 within open capillary 115.

In alternative embodiments, conductive layer 160 may generally be any conductor in the vicinity/near and/or surrounding open capillary 115 such as one or more wires, one or more coiled wires, etc. In yet other alternative embodiments, multiple conductors may be used to recreate the functionality of conductive layer 160.

In some embodiments, open capillary 115 comprises an electromagnetic wave reflector such as reflective layer 150 to the outside and laterally surrounding conductive layer 160. In some embodiments, reflective layer 150 is configured to provide an electromagnetically reflective boundary as will be discussed further below. In some embodiments, open capillary 115 may also comprise insulating layer 165 to the outside and surrounding reflective layer 150. In some embodiments, conductive layer 160, reflective layer 150, and insulating layer 165 may be referred to collective as a multilayer clad surrounding open capillary 115.

In some embodiments, open capillary 115 comprises two nano-orifices: orifice 145 and orifice 147 respectively at the top and bottom of open capillary 115. Orifice 145 and orifice 147 may be connected to a regulated source of gas (near normal temperature and pressure, for example) made of atoms whose nuclei are to interact inside open capillary 115. For example, the gas may comprise low atomic number atoms, such as ¹¹B⁵ and ¹H¹, at near normal temperature and pressure (NTP) conditions. In alternative embodiments, other types of atoms may be used, including atoms of the same type, atoms of two or more different types, etc.

In some embodiments, the capillary may contain a non-equilibrium ensemble in the order of a billion particles. In some embodiments, open capillary 115 may have a radius of 100 nm with orifice 145 and orifice 147 having radii of 1 nm (in the order of the gas particle interspacing distance, for example). Open capillary 115 may have a length/height of 10 mm.

In some embodiments, conductive layer 160 is configured to be coupled to a current nanopulse source, which is configured to generate nanopulse current, Iₚ. In some embodiments, the nanopulse current, Iₚ, may be a pulsed current axially oriented via conductive layer 160, with the pulsed current generating a cylindrical (in embodiments where the conductive layer is cylindrical, for example) electromagnetic wavefront that converges, after being reflected from reflective layer 150, radially inwards toward the axis of cavity 140 of open capillary 115. As discussed above, conductive layer 160 may have other shapes, and as such, other electromagnetic field wavefronts/pulses with alternative profiles may be generated. In alternative embodiments, the current pulse may be sent to one or more multiple conductors located in the vicinity of open capillary 115.

In some embodiments, a set of electrical power-generating capillaries, such as a set of capillaries 15 (described above), may be used (in conjunction with other electronics as needed) to generate the nanopulse current, Iₚ. In alternative embodiments, alternative electronics and alternative electrical power units (as opposed to the set of capillaries 15) may be used to generate a nanopulse current having the proper characteristics as required for the proper operation of open capillary 115. An example profile of the pulsed current, Iₚ, is shown in FIG. 8.

In some embodiments, DC bias voltage source 190 is configured to be connected to conductive layer 160. In some embodiments, the positive terminal of DC bias voltage source 190 may be connected to other parts of conductive layer 160, such as the side portions of conductive layer 160, for example, and the negative terminal may be connected to ground. In alternative embodiments, an electric field profile around the cavity can be generated/established with DC and/or AC voltage sources with other profiles to effect the functionality of DC bias voltage source 190. Other configurations of electrical connections may also be used depending on the number and locations of the conductors present near capillary 115.

In some embodiments, DC bias voltage source 190 applied to conductive layer 160 is configured to generate electric fields that, at least in part, maintain the nuclei within cavity 140 during their interaction. As discussed above, conductive layer 160 may have other shapes, and as such, electric fields with alternative profiles may be generated. It should also be noted that the electromagnetic field pulse/wavefront and the electric fields may be generated using separate conductors/conductive layers. In alternative embodiments, positive voltage may be applied to one or more multiple conductors near capillary 115 or electric field profiles may be generated in alternative methods.

In some embodiments, open capillary 115 is configured to combine two or more types of nuclei that are placed within cavity 140 of open capillary 115 and to generate one or more types of resulting nuclei. In some embodiments, corresponding two or more types of atoms to the two or more types of nuclei may be used. In some embodiments, the atoms may be stripped of their electrons to produce the two or more types of nuclei that are to be introduced into capillary 115.

In some embodiments, the resulting nuclei have high kinetic energy/momentum as a result of the interaction and are directed both toward the top and bottom of open capillary 115 (similarly to the resulting nuclei generated by capillary 15 as discussed above), respectively through orifices 145 and 147. In some embodiments, the momentum of the resulting nuclei may be used to generate thrust to propel open capillary 115 (or the vehicle/ship/craft to which open capillary 115 is attached).

In some embodiments, effusion DC voltage source 197 is configured to be connected to ring electrode 245 and ring electrode 247, which are respectively near orifice 145 and orifice 147. In some embodiments, the positive terminal of effusion DC voltage source 197 may be connected to other parts of conductive layer 160, such as the side portions of conductive layer 160, for example, and the negative terminal may be connected to ground. It should also be noted that ring electrodes 147 and 149 may have various other shapes. For example, the ring electrodes could be a mesh, a thin foil, etc.

In some embodiments, ring electrodes 245 and 247—based at least on the electrodes being connected to the positive of effusion DC voltage source 197—are configured to remove the electrons from the atoms as the atoms enter cavity 140 or capillary 115 to generate positively charged nuclei from the atoms. The positively charged nuclei are to interact within cavity 140.

In some embodiments, open capillary 115 comprises decharging ring 210 forming an orifice through which the generated resulting type of nuclei (based on the interaction within open capillary 115) are configured to pass after exiting through orifice 147. In some embodiments, the generated resulting nuclei are positively charged as the resulting nuclei do not include negatively charged electrons. As used here, the term decharge implies neutralizing by adding electrons, which are the electrons that were removed before the interaction from the atoms to generate the interacting nuclei.

In some embodiments, decharge DC voltage source 195 is configured to be coupled between ground and decharging ring 210, with a negative bias on decharging ring 210. As the positively charged resulting nuclei exit through decharging ring 210, electrons from the negatively charged decharging ring 210 are repelled from decharging ring 210 toward the exiting resulting nuclei and combine with the positively charged resulting nuclei to neutralize the resulting nuclei before the resulting nuclei exit open capillary 115.

In some embodiments, current, I_{d}, is generated by decharging ring 210 as a result of electrons leaving decharging ring 210 and being added to positively charged nuclei. In some embodiments, the electrons/current, I_{d}, may be provided/balanced by electrons/current that are removed from the atoms in the process of removing the electrons from the atoms to generate the positively charged nuclei being introduced into capillary 115.

In some embodiments, decharging ring 210 may have various shapes and be made of various materials other than a ring. For example, decharging ring 210 could be a mesh, a thin foil, etc.

In some embodiments, the energetic resulting nuclei are directed both toward the top and bottom of open capillary 115. As such, in applications where the resulting nuclei are to be used for generating thrust in the upward direction, the resulting nuclei directed toward the top of open capillary 115 may be redirected downwards toward the bottom of open capillary 115. As such, all or substantially all of the resulting nuclei may be directed downwards and thus be generating an upward thrust.

In some embodiments, reflector ring 220 is configured to reverse the direction of any upwards moving positively charged nuclei. In some embodiments, reflection DC voltage source 180 is configured to be coupled to reflector ring 220 as well as ground, with a positive bias on reflector ring 220. An electric field is generated pointing away from reflector ring 220, and as such, the positively charged nuclei are repelled by reflector ring 220 as the nuclei are moving upwards toward reflector ring 220. Based at least on reflector ring 220 being positively biased, the nuclei reverse direction and are headed downwards, joining the nuclei that were originally directed in the downward direction. In some embodiments, the nuclei (whether initially directed upwards and then redirected downwards or initially directed downwards) are decharged by decharging ring 210 before exiting and continuing downwards to generate upward thrust for open capillary 115.

In some embodiments, reflector ring 220 may have various shapes other than a ring and be made of various materials. For example, reflector ring 220 could be a mesh, a thin foil, a solid disk, etc.

In some embodiments, open capillary 115 may have similar specifications and dimensions to capillary 15. in some embodiments, the pulse frequency and the general shape of the current, Iₚ, may be the same for capillary 15 as for open capillary 115.

In some embodiments, the charge carrier exhaust thrust generated in open capillary 115 may be represented by (dm_{cc}/dt)v_{cc}, where the emitted charge carrier mass exhaust rate, dm_{cc}/dt, ≈(3/4) ζ Nₙ m_{cc}fₚ, where ζ, the split fraction, ═10⁻⁴, Nₙ, the number of capillary nuclei, ≈10¹⁰, fₚ, the capillary pulse frequency, ≈10 kHz, m_{cc}, the charge carrier mass, ≈10-27 kg, v_{cc}≈(2 E_{cc}/m_{cc})^{1/2}≈10⁷ m/s, and where E_{cc}, the charge carrier kinetic energy, ≈2.9 MeV.

In some embodiments, the charge carriers emitted from open capillary 115 generate an exhaust thrust≈1 nN. Open capillary 115, set up in such a thrust-generating configuration, may have a length, Lₙ, ≈1 cm, and a current pulse frequency, fₚ, ≈10 kHz, which, in some embodiments, are substantially equal to capillary 15.

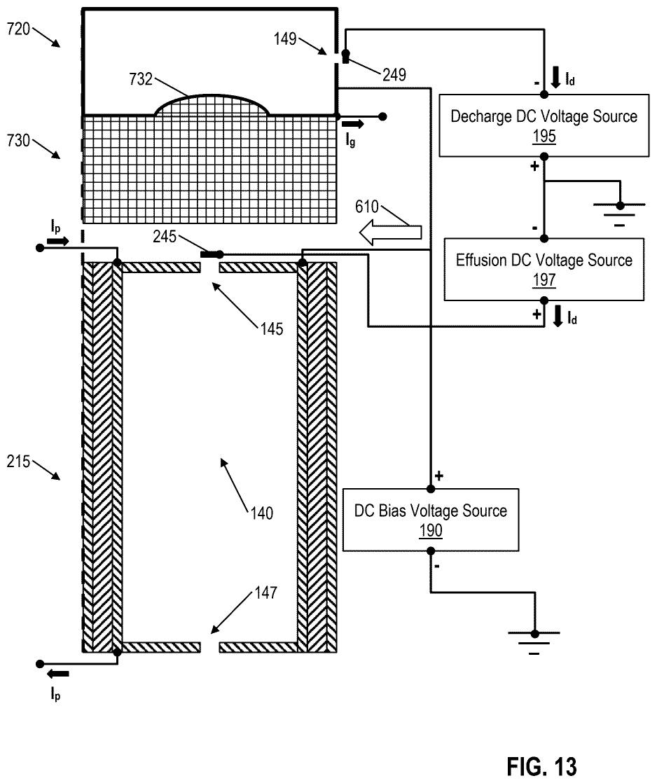

FIG. 13 is sectional view of a quantum capillary with a vent, in accordance with some embodiments.

In some embodiments, capillary 215 is configured to receive gas of atoms 610 (that are to interact within cavity 140 of capillary 215) that enters capillary 215 through orifice 145. In alternative embodiments, gas of atoms 610 may also enter through orifice 147. It should be noted, however, that only one side will be shown and discussed in the figure.

In some embodiments, as the gas of atoms 610 enter cavity 140, effusion DC voltage source 197 (which is connected ring electrode 245 close to orifice 145 with a positive bias) is configured to remove the electrons from one or more types of atoms in gas of atoms 610 to generate one or more types of positively charged nuclei before the nuclei enter cavity 140.

In some embodiments, the positively charged nuclei are to interact within cavity 140 to generate resulting positively charged nuclei. In some embodiments, the resulting nuclei are generated with high kinetic energy and may be directed upwards toward orifice 145 as well as downwards toward orifice 147.

In some embodiments, the upwards moving resulting nuclei are configured to be incident onto collector pixels 730. Collector pixels 730 are configured to generate electrical currents based on the high kinetic energy resulting nuclei collector pixels 730. The generated electrical currents may be collected and output as generated current, I_{g}. It should be noted that downward moving resulting nuclei, though not shown in the figure, may be similarly processed with collector pixels at the bottom of capillary 215.

In some embodiments, after generating current, now slow moving resulting positively charged nuclei may be collected in decharger vent 720, from which they can exit through orifice 149. In some embodiments, electrons may be added to the resulting positively charged nuclei as the nuclei are exiting orifice 149 based at least on orifice 149 having a negative bias by being connected to the negative of decharge DC voltage source 195. Accordingly, neutral atoms are vented out of decharger vent 720.

In some embodiments, in terms of electricity generation, capillary 215 may be considered the anode, and decharger vent 720 and collector pixels 730 may be considered the cathode.

In some embodiments, a positive voltage bias from DC bias voltage source 190 may be applied to capillary 215 as well as vent 720 to facilitate the interaction of the one or more nuclei within capillary 215.

In some embodiments, the atoms being introduced into capillary 215 may be H and B atoms and the resulting atoms vented out of orifice 149 may be He atoms. Charge quantum tunneling in the metastable bond pairs induces Nₚ ζ≈10⁵ cluster states that undergo disintegration by ternary split into stable charge carriers of high kinetic energy and high-electron-dislodging efficiency. The pulse-induced energy generated in the cavity is E_{g}≈Nₚ ζE_{cc}≈100 nJ where the kinetic energy of the emitted charge carriers is E_{cc}≈1 pJ. The cavity electromagnetic pumping provides the nuclei nanocloud with pulse energy Ep≈Iₚ Vₚ τₚ≈10 pJ that consecutively induces nuclei intercalation, doublet coupling and nanocloud focalization during each pulsation.

In some embodiments, the momentum-conserving ternary emission from chain integral cluster states leaves no recoiling residual nucleus. The pulse focalizing electromagnetic wavefront holds charge carrier uniform motion near the axis balancing Coulomb divergence while charge carriers transition to an axial channeling state. Focalizing energy densities for the induction of charge carrier channeling per pair ternary emission and for the induction of 1D focalization phase per doublet, are considered equivalent, with equal charge and mass in both bosonic states. Hence, both states energy densities on the channeling radius and on the threshold radius are about equal u_{cc}(r=r_{cc})≈u_{d}(r=rₜₕ). The charge carrier axial channeling radius is then given by r_{cc}≈(E_{cc}/E_{d}(r=ₜₕ)½ rₜₕ=100 pm, with an established non-relativistic axial ballistic charge carrier channeling of speed v_{cc}≈10⁷ m/s and high magnetic rigidity≈0.1 GT m. In the channeling state, the focalizing force at the channeling radius is dominant over the emitted charge carrier divergence force.

In some embodiments, the channeling ballistic motion of the emitted charge carriers through the nanopores with E_{cc}>q_{cc} Vₒₑ, and towards the top and bottom split cathode collector thin film pixels, is sustained by the cavity pulse during the charge carrier collection time Lₙ/v_{cc}≈1 ns=τ_{f} with τ_{f}>>τ_{qt}. Electrons dislodged in the charge-coupled cathode pixels through high-energy charge carrier interaction are collected in band-gap quantum wells for subsequent release as an electron current. After the cavity pulse, the nanocloud nuclei lost due to the nuclei residual strong interaction are replaced via nanopore particle effusion within the cavity pulsation period.

In some embodiments, a basic micromodule is considered with an embedded quantum capillary lattice array where each capillary consists of a clad cavity capped by a split cathode (a quantum capillary diagram is shown in FIG. 1). The 1 cm³ integrated micromodule includes an anode with vertically aligned capillary lattice pattern (κ×κ)=100×100 consistent with a 1 s high-duty-cycle operational time and a split charge-coupled cathode. The anode is made of axially aligned cavities with geometrically symmetric top and bottom bases. The split cathode includes domed, electron-collecting pixels of width≈100 μm acting as low-pass energy charge carrier filters. The anode contains 104 cavities of length 10 mm and radius≈100 nm, biased with voltage V_{b}≈100 mV. The cavities are electrically connected with ring electrodes in series with separation≈100 μm. The micromodule operation requires cavity pulsation of amplitude Iₚ≈1 mA, duration τₚ≈1 ns, voltage Vₚ≈10 V and repetition rate fₙ=10 kHz where (κ×κ) τₚ<τₚₚ. Self-pumping with fractional recirculation of generated current into a serial line electron nanopulser and potential step electrode matching the pulse cavity voltage, provides electromagnetic pumping to all the array cavities. The micromodule capillary array is loaded by a regulated stoichiometric near-NTP gas source through top-bottom anode-cathode gaps of size z_{ac}≈10 nm larger than dₑ and consistent with mapping of a capillary cavity emission into its cathode collector pixel top dome. Replacement of operational particle losses on all cavities takes place between pulsations.

In some embodiments, a quantum capillary cavity contains Nₙ≈10¹⁰ h,b nuclei that generate charge carriers with channeling induced by the focalization pulse. The emitted high-kinetic-energy charge carriers egressing from the cavity with r_{cc}<rₒ, diverge into top and bottom split cathode collector pixels with free Coulomb gap transmission radial divergence≈z_{ac}. The electron-collecting pixel charge carrier flow of ≈10⁶/pulse, dislodges valence electrons with average electron dislodging energy E_{ed}≈10 aJ. The cathode collector pixels with atomic spacing≈0.1 nm, are set for charge carrier electron dislodging with a charge collection efficiency δ≈1, that accounts for the charge carrier high-electron-dislodging efficiency and for a pixel phonon emission time (≈100 ps) longer than the electron dislodging time (≈100 as). Free low-energy charge carriers transmitted out of tuned cathode collector pixels into the capillary's vent (≈100 μm) are pressure-gradient individually egressed through a V_{d}≈−10 V negatively biased nanopore with decharging by electron field emission of electrons stripped off via cavity gas effusion, where the V_{d} potential is higher than the nanopore work function and the decharge nanopore radius r_{d}≈1 nm is smaller than the mean free path and larger than the emitted electron wavelength. A pulse capillary emission moves valence electrons to the conduction band with ≈100 μC/pixel/s on cathode collector pixels of thickness≈10 μm. Distributed PIN-junction quantum wells with collection saturation level≈10⁵ electrons/depletion width μm/active width μm, have their band-gap electron accumulation released to an external circuit after each pulsation. The cathode collector pixels draw out rate is 10 kHz and the electron release period is τ_{g}≈10 ns. The micromodule generated electron current of ≈1 C/s with electron release rate 10 kHz and period (κ×κ) τ_{g}≈100 μs, is transformed into ≈1 A CW DC current by DC-DC conversion.

In some embodiments, the electron direct current generated at the micromodule charge-coupled cathode is given by I=ß Nₙ ζ E_{cc} (κ×κ)fₙ δ/2 E_{ed}≈1 A. The 1 A DC current generation capacity is provided by a 1 cm³ integrated quantum capillary lattice micromodule with solid state current collection system as follows: 100×100 capillary pattern anode, 100 nm cavity radius, 10 mm cavity length, 100 mV cavity bias voltage, cavity pulsation of 1 mA amplitude 1 ns duration and 10-kHz repetition rate, 1 V open-circuit voltage, 1 s operational cycle time, and 1 nl/s flow from a regulated stoichiometric near-NTP gas source.

In some embodiments, the micromodule electron current amplification derives from the quantum capillary capability for low-Z fermionic nuclei nanocloud picofocalization to a macroscopic 1D chain state and the subsequent spatially-degenerate pair quantum tunneling exposure inducing nuclei residual strong interaction with emission of high-energy charge carriers. The micromodule quantum tunneling exposure ε_{qt}, that is the number of nuclei exposed to spatially-degenerate pair quantum tunneling for residual strong interaction in an operational cycle time is given by (ß Nₙ/2) (κ×κ) fₙ≈10¹⁸/cm³/s. In this context, quantum capillary lattices can be the basis for scaled up cellular current and conformal thrust generation systems.

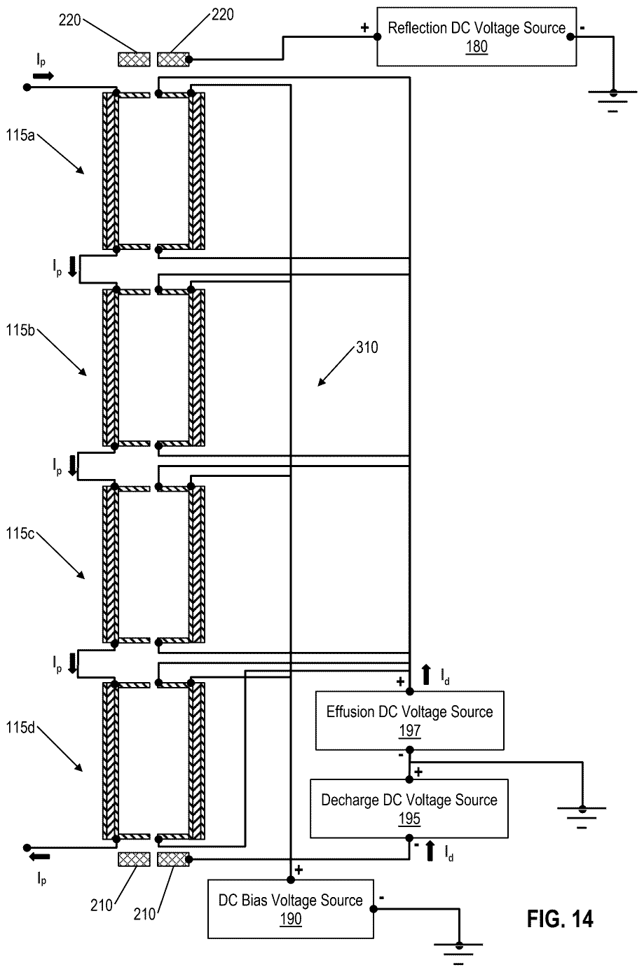

FIG. 14 is a cross-sectional view of a capillary link, in accordance with some embodiments.

In some embodiments, open capillaries may be arranged in series as well as in parallel to significantly multiply/increase the amount of thrust generated.

In some embodiments, two or more open capillaries may be arranged in series to form a capillary link, such as capillary link 310. Capillary link 310, as shown in FIG. 14, comprises four open capillaries: open capillary 115a, open capillary 115b, open capillary 115c, and open capillary 115d. In alternative embodiments, a higher or a lower number of open capillaries may be used in a series configuration to form capillary link 310.

In some embodiments, the open capillaries that are in series with each other may share certain components. For example, a single decharging ring 210 may be used at the bottom of the series configuration. As such, the single decharging ring 210 may be used to neutralize nuclei generated by any open capillaries 115a-d in capillary link 310.

Similarly, a single reflector ring 220 may be used at the top of the series configuration. As such, the single reflector ring 220 may be used to redirect downwards any upward moving nuclei generated by any open capillaries 115a-d in capillary link 310.

In some embodiments, the open capillaries that are in series configuration may also be wired in series with each other as shown in FIG. 14. In such embodiments, currents, such as currents I_{d} and Iₚ can flow through the lines and/or the open capillaries in series as shown in the figure to and from effusion DC voltage source 197 and decharge DC voltage source 195. Similarly, a single connection at the top and a single connection at the bottom may be used for the current Iₚ. Also, similar connections may be made for DC bias voltage source 190 may be made to provide a positive bias to all the capillaries.

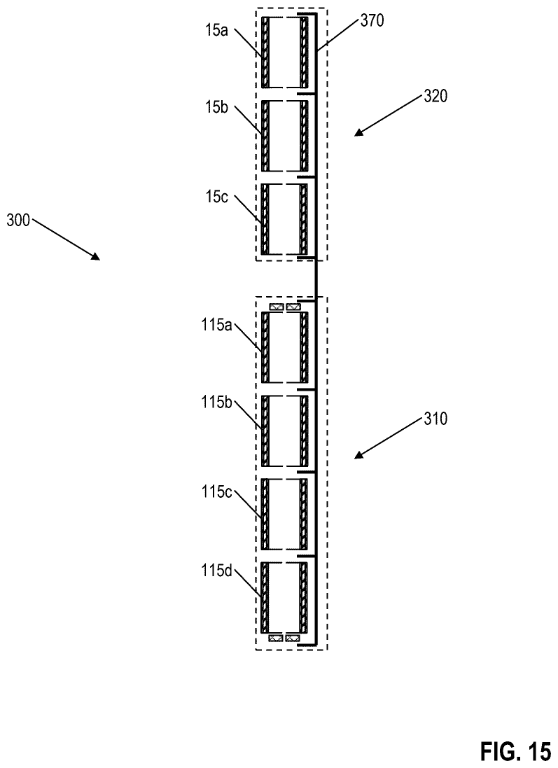

FIG. 15 is a cross-sectional view of a capillary cell rod, in accordance with some embodiments.

In some embodiments, a capillary link, such as capillary link 310 (which includes 115a-d), may be connected to two or more electricity-generating capillaries, such as group of capillaries 320 (which includes capillaries 15a-c), to form a capillary cell rod, such as capillary cell rod 300.

In some embodiments, group of open capillaries that are configured to generate thrust may be paired with a group of electricity-generating capillaries so that the electricity-generating capillaries can generate and provide the pulse current, Iₚ, to the group of open capillaries.

In some embodiments, conduit 370 may be used to couple capillaries 15a-c of group of capillaries 320 and open capillaries 115a-d of capillary link 310. In some embodiments, conduit 370 may include lines for fed gases and lines for helium coolant (as may be discussed below) that may be fed to the capillaries as well as electrical lines to accommodate all the required electrical connections between the capillaries.

It should be noted that various other devices and sources, other than electricity-generating capillaries, may be used to generate and provide the pulse current, Iₚ, and other electrical signal requirements to the group of open capillaries 310.

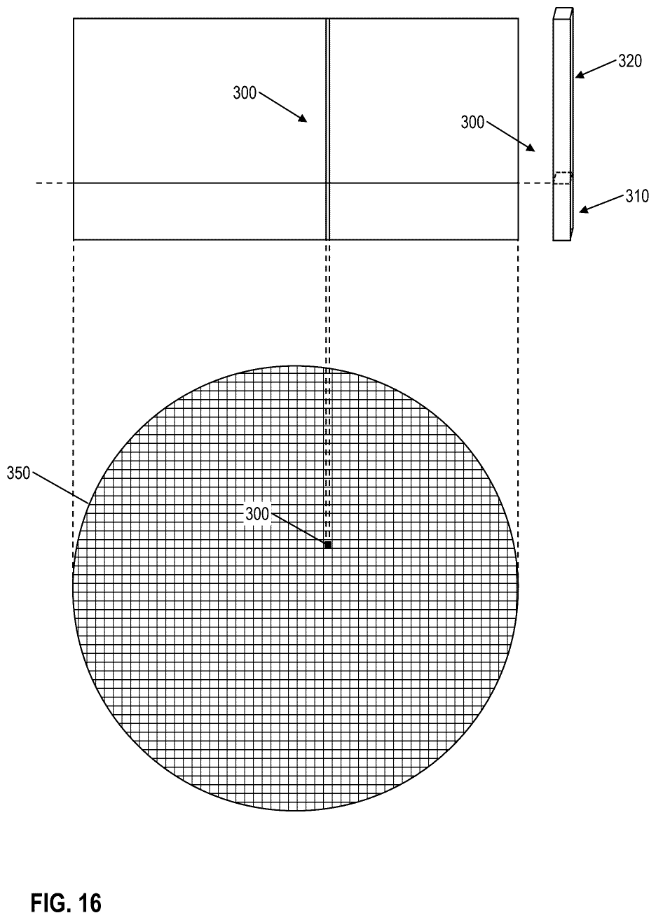

FIG. 16 is a cross-sectional view as well as a top view of a disk arrangement of thrust cells, in accordance with some embodiments.

In some embodiments, a dense capillary link thrust cell, such as dense capillary link thrust cell 300 may be arranged in a lattice to form dense capillary link thrust disk 350, to multiply the amount of generated thrust from a single capillary link. In some embodiments, dense capillary link thrust disk 350 may be arranged in a circle, forming a thrust-generating cylinder as is shown in the figure. The figure shows a top view of dense capillary link thrust disk 350 and a side view of dense capillary link thrust disk 350 above the top view as well as a single capillary thrust cell rod 300.

In some embodiments, dense capillary link thrust disk 350 may be used in space exploration as dense capillary link thrust disk 350 can generate a relatively large amount of thrust with a relatively small amount of fuel. The strong interaction energy released within each capillary allows for minimal fuel mass consumption and the generation of a high-energy charged particle exhaust. In some embodiments, dense capillary link thrust disk 350 may be used to power a spacecraft between low Earth orbit and low Mars orbit, for example.

In some embodiments, the supply pulses, voltages, fed gas, helium coolant, etc. to the capillaries may be handled through microline bundles, with one bundle per 104-capillary array, for example, and may be placed within ≈10 μm multilayer thin film cell on the sides and top/bottom bases throughout each row connecting all the capillaries. A container disk≈1 m thick may be located over the group of capillaries to remove heating losses in the quantum capillary lattice system. A helium container, for example, may be row-connected to the group of capillaries and open capillary links for axial cooling of high-surface anode cavities and thrust cells during operation. The closed-cooling-loop row Helium flow may be regulated out of the container into the current cell and thrust cell cavity interstices through row thrust cell side supply microlines by pressure gradient.

In some embodiments, dense capillary link thrust disk 350 may be operated with an effusion DC voltage, V_{b}, ≈100 mV and capillary packing pattern (κ×κ)=100×100 per capillary thrust cell array, for example. In some embodiments, the serially connected open capillaries may receive 1 mA, 10 KHz pulses with periodic current pulses of width, τₚ, ≈1 ns and frequency, fₚ, ≈10 KHz.

In some embodiments, a capillary link may be considered with length L≈4 cm and pulse frequency fₚ=10 kHz, including four, in some embodiments, axially linked thrust open capillaries. The open capillaries may be refilled through top and bottom orifices during the time between pulses, τₚₚ≈100 μs. The capillary link current pulse of width, τₚ≈6 ns, satisfies (κ×κ) τₚ<τₚₚ and accounts for a focalization time, τ_{f}, ≈charge carrier collection time=2 L/v_{cc} and for a coupling time, τ_{c}, that has no L dependence.

In some embodiments, a capillary link includes a top reflector of central orifice radius≈1 nm with bias voltage, V_{f}, ≈+10 V and bottom emission decharger. The decharger neutralizes the charged particle emission exhaust, and it may be a graphene-type, electron-field-emission orifice of thickness≈0.1 μm with a bias voltage, V_{d}, ~−10 V and central orifice of radius≈1 nm.

in some embodiments, the electrons required by the decharger may be taken from the charge-balance-matched orifice electrons taken from the effusing gas introduced into the thrust capillaries. In some embodiments, decharger electrons may flow through graphene-type lines with serial connection of electrodes connected to effusion and decharger voltage sources. The continuous capillary link charge carrier channeling is maintained by a focalization pulse synchronized for linked pumping of capillaries. The charged particle generated capillary thrust is proportional to Ln. The thrust of a capillary link in such a configuration is ≈8 nN.

In some embodiments, the current cell configuration may have a capillary packing pattern (κ×κ)=102×102 with corresponding charge-coupled-cathode pixels set according to the same capillary packing pattern and a capillary separation distance=100 μm. The current cell may be fed electronic pulses by one electron nanopulser and generate a current≈1 A. A thrust dense cell may have a capillary link configuration (κ×κ)=(4×104×4×104) with separation distance between capillaries=0.25 μm. The thrust dense cell is fed electronic current by 1.6×10⁵ pulsers. A thrust cell is a dense cell with capillary links that may generate an exhaust thrust≈12 N.

In some embodiments, a quantum capillary lattice space stage may include a cellular power plant (comprising electricity-generating capillaries) and a conformal space thruster (comprising thrust-generating open capillaries). These stage components may be a honeycomb-structure, cell disk sandwich that is frame supported within a cylindrical stage fuselage. Two circular disks of 9 m diameter with 0.6×106 cells tiled in the stage cross section may be considered for power plant and thruster.

In some embodiments, the power plant considered is a 16 cm thick disk with cross section of 0.6×10⁶ cells and with vertical cell rods where all 16 cells in the disk may have a standard (κ×κ)=100×100 capillary pattern. In some embodiments, the modular power plant provides ≈10 Mwe. The power plant disk may have a total of 9.6×106 standard cells with an output voltage of 1 V and uses current recirculation for capillary pulsation. Less than 1% of the power plant output current is used for the power plant disk and thruster disk pulses at 10 kHz throughout the thruster operation; the rest of the produced power may be provided for other uses.

In some embodiments, the thruster may be a 4 cm thick disk with cross section of 0.6×106 thrust cells with dense (κ×κ)=4×104×4×104 capillary pattern. Each thrust cell vertically may include: a top emission reflector, four serially connected linked thrust capillaries with dense capillary pattern, and a bottom emission exhaust decharger. The pulse current for the capillary link may be supplied by the power plant. Each cell decharger may be fed by ≈10 nA, drawn from the orifices in the thrust cell's capillary links. Thus, the quantum capillary thruster may generate 7.2 MN of thrust with 1.2 Ms specific impulse.

In some embodiments, power plant output current of 10 capillaries per cell and rod is directly matched, synchronized, and transferred to the rod thrust cell in each pulse to operate the thruster at 10 kHz pulsation rate. The space stage may be a passive system with no moving parts for operation.

In some embodiments, quantum capillary lattices are consistent with scaled up conformal thrust generation for direct port-to-port flight with no refueling, powered reentries, and directional thrust generation. For example, for a flat-base spacecraft with quantum capillary lattice thruster of four times the free thrust-cell-tiled surface radius (α≈103, T≈100 MN, T/m≈100), and overall mass a fourth by elimination of fuel mass, the Earth-to-Mars (E-to-M) time may take a few days, for example.

It is understood that the implementation of other variations and modifications of the present invention in its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

One or more embodiments of the invention are described above. It should be noted that these and any other embodiments are exemplary and are intended to be illustrative of the invention rather than limiting. While the invention is widely applicable to various types of systems, a skilled person will recognize that it is impossible to include all of the possible embodiments and contexts of the invention in this disclosure. Upon reading this disclosure, many alternative embodiments of the present invention will be apparent to persons of ordinary skill in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations that follow those terms. Accordingly, a system, method, or other embodiment that comprises a set of elements is not limited to only those elements and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method comprising:
introducing one or more types of nuclei into a cavity of a capillary;
sending a current pulse through at least one of one or more conductors, wherein the current pulse is configured to generate an electromagnetic field pulse within the cavity;
applying a positive voltage to at least one of the one or more conductors;
causing a focalization of the one or more types of nuclei based at least on the sending the current pulse and the applying the positive voltage;
causing an interaction of the one or more types of nuclei based at least on the focalization;
causing a generation of one or more resulting types of nuclei based at least on the interaction of the one or more types of nuclei, wherein the one or more resulting types of nuclei acquire kinetic energy based at least on the interaction of the one or more types of nuclei, wherein a subset of the resulting types of nuclei moves in an upward direction and another subset of the resulting types of nuclei moves in a downward direction;
redirecting the subset of the resulting types of nuclei moving in the upward direction to create redirected resulting types of nuclei moving in the downward direction; and
generating thrust in the upward direction based at least on the redirected resulting types of nuclei moving in the downward direction and on the other subset of the resulting types of nuclei moving in the downward direction.

2. The method of claim 1, wherein the redirecting comprises redirecting using an electric field generated by a positive voltage bias on a reflector ring.

3. The method of claim 1, comprising decharging and neutralizing the redirected resulting types of nuclei moving in the downward direction and the other subset of the resulting types of nuclei in the downward direction by adding electrons.

4. The method of claim 3, wherein the decharging and neutralizing comprises passing the redirected resulting types of nuclei and on the other subset of the resulting types of nuclei through a decharging ring.

5. The method of claim 3, wherein additional capillaries are in series above and/or below the capillary, wherein the additional capillaries and the capillary form a capillary link, wherein the redirecting occurs at a top of the capillary link, and wherein the neutralizing occurs at a bottom of the capillary link.

6. The method of claim 1, wherein the capillary, the cavity of the capillary, and at least one of the one or more conductors are a cylindrical shape, wherein the at least one of the one or more conductors extends to a lateral surface of the cylindrical shape, a top surface of the cylindrical shape, and a bottom surface of the cylindrical shape, and wherein the focalization occurs along a cylindrical axis of the cavity of the capillary.

7. The method of claim 6, wherein the introducing comprises introducing the one or more types of nuclei into the cavity of the capillary through a top orifice of the capillary centered on the cylindrical axis of the cavity and a bottom orifice of the capillary centered on the cylindrical axis of the cavity.

8. The method of claim 1, comprising:
providing a gas of one or more types of atoms;
removing electrons from the one or more types of atoms to yield the one or more types of nuclei.

9. The method of claim 8, wherein the removing the electrons comprises removing the electrons by applying an effusion voltage to electrodes near a top orifice of the capillary and to electrodes near a bottom orifice of the capillary.

10. The method of claim 8, wherein the removing the electrons comprises removing the electrons by applying the positive voltage to at least one of the one or more conductors.

11. The method of claim 1, comprising causing a reflection of the electromagnetic field pulse within the cavity using at least one of one or more electromagnetic reflectors surrounding at least one of the one or more conductors.

12. The method of claim 1, wherein causing a focalization comprises causing a bounded-chain focalization.

13. The method of claim 1, wherein the one or more types of nuclei are ¹H¹⁺ nuclei and ¹¹B⁵⁺ nuclei in a one-to-one ratio and wherein the one or more resulting types of nuclei are ⁴He²⁺ nuclei in a three-to-one ratio of the ¹H¹⁺ nuclei and to the ¹¹B⁵⁺ nuclei.

14. A system comprising:
a capillary, wherein the capillary comprises a cavity within the capillary and one or more conductors near the cavity;
a supply source of one or more types of nuclei;
a pulsed current source coupled to at least one of the one or more conductors;
a voltage source coupled to at least one of the one or more conductors;
a reflector above the cavity;
wherein:
the cavity is configured to receive the one or more types of nuclei,
the pulsed current source is configured to send a current pulse along at least one of the one or more conductors, wherein the current pulse is configured to generate an electromagnetic field pulse within the cavity,
the voltage source is configured to apply a positive voltage to at least one of the one or more conductors,
the positive voltage and the electromagnetic pulse are configured to focalize the one or more types of nuclei and to cause the one or more types of nuclei to interact and to generate one or more resulting types of nuclei acquiring kinetic energy,
a subset of the resulting types of nuclei moves in an upward direction and another subset of the resulting types of nuclei moves in a downward direction,
the reflector is configured to redirect the subset of the resulting types of nuclei moving in the upward direction to create redirected resulting types of nuclei moving in the downward direction,
thrust is generated in the upward direction based at least on the redirected resulting types of nuclei moving in the downward direction and on the other subset of the resulting types of nuclei moving in the downward direction.

15. The system of claim 14, wherein the reflector is configured to redirect based at least on the reflector being configured to receive a positive voltage bias and to generate an electric field away from the reflector.

16. The system of claim 14, comprising a decharger below the cavity, wherein the decharger is configured to decharge and neutralize the redirected resulting types of nuclei and the other subset of the resulting types of nuclei.

17. The system of claim 14, comprising additional capillaries in series above and/or below the capillary, wherein the additional capillaries and the capillary form a capillary link, wherein the reflector is at a top of the capillary link, and wherein the decharger is at a bottom of the capillary link.

18. The system of claim 14, wherein the capillary, the cavity of the capillary, and at least one of the one or more conductors are a cylindrical shape, wherein the at least one of the one or more conductors extends to a lateral surface of the cylindrical shape, a top surface of the cylindrical shape, and a bottom surface of the cylindrical shape, and wherein the positive voltage and the electromagnetic pulse are configured to focalize the one or more types of nuclei along a cylindrical axis of the cavity of the capillary.

19. The system of claim 14, comprising at least one orifice at either a top or a bottom of the cavity, wherein the one or more types of nuclei are configured to enter into the cavity through the at least one orifice.

20. The system of claim 19, comprising at least one electrode near the orifice, wherein an effusion voltage is applied to the electrode, and wherein the electrode is configured to remove electrons from one or more types of atoms entering the cavity to yield the one or more types of nuclei.

21. The system of claim 14, comprising at least one electromagnetic reflector around at least one of the one or more conductors, wherein the at least one electromagnetic reflector is configured to reflect the electromagnetic field pulse within the cavity.

22. The system of claim 14, wherein the positive voltage and the electromagnetic field pulse are configured to bounded-chain focalize the one or more types of nuclei.

23. The system of claim 14, wherein the one or more types of nuclei are ¹H¹⁺ nuclei and ¹¹B⁵⁺ nuclei in a one-to-one ratio and wherein the one or more resulting types of nuclei are ⁴He²⁺ nuclei in a three-to-one ratio to the ¹H¹⁺ nuclei and to the ¹¹B⁵⁺ nuclei.
